(19) United States
(12) Patent Application Publication
(10) Pub. No.: US 2015/0289950 A1
(43) Pub. Date: Oct. 15, 2015

(54) ADHESION PADS FOR FASTENING AN ORTHODONTIC ALIGNER

(71) Applicant: ORTHO CAPS GMBH, Hamm (DE)

(72) Inventor: Wajeeh Khan, Hamm (DE)

(21) Appl. No.: 14/688,583

(22) Filed: Apr. 16, 2015

Related U.S. Application Data
(63) Continuation of application No. PCT/EP2013/071725, filed on Oct. 17, 2013.

(30) Foreign Application Priority Data
Oct. 17, 2012 (DE) 10 2012 109 877.8

(51) Int. Cl. A61C 7/08; G06F 17/50; G05B 19/4097; A61C 7/00

(52) U.S. Cl. CPC A61C 7/08; A61C 7/002; G06F 17/50; G05B 19/4097; A61C 2007/004; G05B 2219/35012

(57) ABSTRACT

The invention relates to an adhesion pad for fastening an orthodontic aligner, wherein the adhesion pad comprises a substantially flat structure, which can be applied to the surface of at least one tooth, and wherein said adhesion pad has at least one side having a modified surface, which increases the adhesion of the adhesion pad to the aligner. Alternatively, the invention relates to an adhesion pad for fastening an orthodontic aligner, wherein the adhesion pad comprises a substantially flat structure and has a modified surface, which strengthens the adhesion of the adhesion pad to the tooth surface, and wherein said flat structure a) can be arranged on the inner surface of said aligner or b) is an integrated region of said aligner that protrudes on the inside of the aligner.

### CROSS-REFERENCE TO RELATED APPLICATIONS

The present application is a continuation and claims priority under 35 U.S.C. §120 and §365(c) to PCT International Patent Application PCT/EP2013/071725, filed Oct. 17, 2013, which claims priority to German Patent Application No. 10 2012 109 877.8, filed Oct. 17, 2012, each of which are incorporated herein by reference in their entireties.

### BACKGROUND

Aligners are patient-adjusted orthodontic appliances, usually composed of a transparent plastic, which are used for the alignment and straightening of teeth as an alternative to traditional metal dental brackets. Like dental braces, aligners are instrumental in adjusting positions of a patient's teeth in regard of their bites and thus correcting orthodontic malpositions, such as abnormal occlusions.

In the conventional aligner-based treatment, so-called attachments are arranged on those teeth, where difficult or problematic adjustments or straightenings can be expected. Such attachments are consisting of little blocks, which are fixed on the tooth surface or hardened on the same, e.g., by light-induced polymerization. Such attachments correspond to respective cavities in the particular aligner, wherein the aligner is positioned over the attachments in such a way that the latter fit into the respective cavities.

Such attachments, which are disclosed, e.g., in European patent EP1143872B1, do not only allow for a safe fit of the respective aligner, but they can also effectively transfer correcting or stabilizing forces upon those teeth, which have to be twisted or moved more than other teeth.

Conventional attachments are readily visible, uncomfortable for the patient, and partly inefficient in terms of the desired results. Furthermore, they carry the risk of permanent skin irritations and of injuries of the oral mucosa, especially by sharp edges and surfaces which can get in contact with the oral mucosa. In addition, they are comprised of a carrier material which can promote growth of bacteria and thus favor oral infections, periodontosis and caries due to their irregular shapes—especially because such attachments often feature so-called undercuttings which can hardly be reached by conventional tooth cleaning.

### SUMMARY OF THE INVENTION

It is thus an object of the present invention to provide methods and appliances which eliminate said disadvantages.

It is another object of the present invention to provide methods and appliances which grant a tight fit of the aligner and/or a good transfer of the adjusting and stabilizing forces onto particular teeth without carrying the risk of permanent skin irritations and injuries of the oral mucosa and/or promoting bacterial growth.

It is yet another object of the present invention to provide methods and appliances which grant a tight fit of the aligner and/or a good transfer of the adjusting and stabilizing forces onto particular teeth, and in addition which are esthetically amenable, comfortable for the patient and efficient in terms of the desired results.

These objects are met with methods and means according to the independent claims of the present invention. The dependent claims relate to preferred embodiments. Value ranges delimited by numerical values are to be understood to always include the said delimiting values.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 shows an aligner 11 for correction of the dental position of a patient, corrected in perspective view from below. In this figure the space that is occupied by the patient's teeth when applied as intended, is visible. Said aligner is made, for example, of a transparent synthetic material. Said aligner carries an adhesion pad 10 on its inner face, which is attached there, for example, by an adhesive (“aligner mountable adhesion pads”).

FIG. 2A shows an aligner 21 for correction of the dental position of a patient, corrected in perspective view from below. In this figure the space that is occupied by the patient's teeth when applied as intended, is visible. Said aligner is made, for example, of a transparent synthetic material. Said aligner carries an adhesion pad 20 on its inner face, which is an integrated component of the former and protrudes at its inner face (“aligner-integrated adhesion pad”). FIG. 2B next to it shows a second aligner 21 which does not comprise adhesion pad-mounting cavities and otherwise features identical dimensions as the aligner 21 in FIG. 2A.

FIG. 3 shows a jaw of a patient 31, or a positive model thereof, as well as an adhesion pad 30, attached to the surface of a tooth 32, which needs to be twisted or moved in order to correct its position (“tooth-mountable adhesion pads”). Said adhesion pad essentially consists of a flat structure which comprises a modified surface that increases its adhesion to the dental surface. Said modification consists, e.g. of a structure profile 33. Another embodiment of an adhesion pad is also depicted in FIG. 3, wherein the adhesion pad 34 is stretched over the entire lateral surface of a tooth. The adhesion pad can also be attached around two or three or all faces of the tooth (not shown).

FIGS. 4A and 4B show transfer trays 41 comprising cavities 40 for reception of tooth-mountable adhesion pads 40. Such transfer tray serves for indirect transfer of said tooth-mountable adhesion pads to the dental surface. Alternatively, the cavity 40 of the transfer tray 41 can also be filled with a polymerizing material (e.g. a light-hardening synthetic material). When the transfer tray is placed onto one tooth or several teeth or the entire jaw of the patient, the polymer-forming material can be polymerized and thereby hardened on the dental surface. When the transfer tray is removed, a tooth-mountable adhesion pad remains attached at the dental surface.

FIG. 5A shows a cross section through an aligner along the line A-A′ in FIG. 1. Thereby the features of an aligner-mountable adhesion pad 51 are shown which comprises a modified surface 52 that increases attachment of the same to the dental surface.

FIG. 5B shows a cross section through an aligner along the line B-B′ in FIG. 2. Thereby the features of an aligner-integrated adhesion pad 53 are shown which comprises a modified surface 54 that increases attachment of the same to the dental surface.

FIG. 5C shows a cross section through a transfer tray along the line C-C′ in FIG. 4. Thereby the features of a cavity 55 for reception of a tooth-mountable adhesion pad or for filling with a polymerizing material are shown.

FIG. 5C can also show a cross section through an aligner along the line C-C′ in FIG. 4. Thereby the features of a cavity 55 are shown whose dimension and position correspond to those of the adhesion pad(s) positioned or to be positioned on the teeth.

FIG. 5D shows a cross section through an aligner along the line B″-B″ in FIG. 2B which, however, does not comprise a cavity (56) for the adhesion pads but otherwise is identical with the aligner of FIG. 4 (not shown).

FIG. 6 shows a cross section through a tooth along the line D-D′ in FIG. 3, which demonstrates how the tooth-mountable adhesion pad 61 is placed on the tooth 62 which needs to be twisted or moved in order to correct its position. Unlike shown in FIG. 6, the adhesion pad can feature other forms (square, rectangular, polygonal, adjusted to the form of the target tooth).

FIG. 7 shows the jaw of a patient, or a model thereof, and its 3-dimensional alignment to the three Cartesian axes in a 3-dimensional system. A Cartesian coordinate system for a 3-dimensional area consists of an arrangement of three axes, two of which always form a rectangular angle with each other. These axes are often termed by x, y and z.

FIG. 8: A. Aligner with pull-off device, pull-off model (without adhesion pads), and deep-drawing model (from left to right). B. Enlarged view of the pull-off device. C. Pull-off device with adhesion pads. D. Deep-drawing model with cylinder.

FIG. 9: Test facility with force measuring apparatus, fixation clips, fixed experimental model and aligner with pull-off steel eye bolt as shown in FIG. 8B, wherein the respective aligners HardCaps, DayCaps and SoftCaps were fixed with one steel eye bolt each and measured.

FIG. 10: Results of pull-off experiments of all aligners (Hard-Caps, Day-Caps, Soft/Night-Caps) on models without friction pads and on models with friction pads are shown in the table. 30 experiments per aligner were performed and the pull-off force N was measured. Percentage values refer to the comparison between aligner with friction pads and aligner without friction pads. For example, 160% more pull-off force is required for a DayCap aligner if the same is positioned on a pull-off model with friction pads attached at the dental positions 24 and 26, as compared to a pull-off model without friction pads.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention

Before the invention is described in detail, it is to be understood that this invention is not limited to the particular component parts of the devices described or process steps of the methods described as such devices and methods may vary. It is also to be understood that the terminology used herein is for purposes of describing particular embodiments only, and is not intended to be limiting.

It must be noted that, as used in the specification and the appended claims, the singular forms “a,” “an”, and “the” include singular and/or plural referents unless the context clearly dictates otherwise. It is moreover to be understood that, in case parameter ranges are given which are delimited by numeric values, the ranges are deemed to include these limiting values.

According to a first aspect of the present invention, an adhesion pad for fastening an orthodontic aligner is provided, wherein the adhesion pad comprises a substantially flat structure, which can be applied to the surface of at least one tooth. Said adhesion pad has at least one side having a modified surface, which increases the adhesion of the adhesion pad to the aligner. This kind of adhesion pad is also called “tooth-mountable adhesion pad”.

The term “aligner” is used here as a synonym for the terms “retainer”, “positioner” and “splint”. Though the literature sometimes distinguishes between aligners and retainers in so far as aligners are intended to bring about an active change of the tooth position, whereas retainers are only intended to fix or establish a change of the tooth position yielded in a different way, but this differentiation has not been consequently used in the literature. Ultimately, however, it does not make a difference whether a plastic appliance exerts forces upon a tooth in order to actively change its position, or only in order to fix this position.

These kinds of adhesion pads can be mounted on the teeth either from the cheek or from the tongue side. Alternatively, the pads can also be attached from the lip side. Furthermore, a present adhesion pad can cover the entire surface of a respective tooth, or only a particular area of the respective tooth, depending on which kind of repositioning of the teeth is desired.

According to another embodiment of the present invention, an adhesion pad for fastening an orthodontic aligner is provided, wherein the adhesion pad comprises a substantially flat structure and has a modified surface, which strengthens the adhesion of the adhesion pad to the tooth surface. Said flat structure can either a) be arranged on the inner surface of said aligner or b) is an integrated region of said aligner that protrudes on the inside of the aligner.

These kinds of adhesion pads can also be mounted on the aligner either from the cheek or from the tongue side. Alternatively, the pads can also be attached from the lip side. Furthermore, a present adhesion pad can cover the entire surfaces of the respective teeth, or only a particular area of the respective teeth, depending on which kind of repositioning of the teeth is desired.

In the following, the former embodiment will be termed “aligner-mountable adhesion pad”, whereas the latter embodiment will be termed “aligner-integrated adhesion pad”. In the present context, the term “inner surface of an aligner” shall refer to the surface of an aligner which when used is directed towards the teeth or the jawbone.

In all three disclosed embodiments said adhesion pads increase the adhesion between the aligner and one or all target teeth and thus improve force transmission and tightness of the fit. As described above, therefore, the adhesion pads are suited to transfer correcting or stabilizing forces upon the teeth without causing those problems associated with the use of attachments. Thereby, they enhance the wearing comfort for patients and reduce the risk of injuries and inflammations.

As will be elaborated upon further below, the present invention in one of its embodiments also refers to aligners which do not feature aligner-integrated and/or mountable adhesion pads or which are virtually and/or physically manufactured on a positive model, respectively, which do not feature adhesion pads. In one embodiment, the aligner provided by the present invention is at least partially decreased in size.

It is preferred that said adhesion pad has a thickness of (in mm) 0.1; 0.2; 0.3; 0.4; 0.5; 0.6; 0.7; 0.8; 0.9; 1; 1.1; 1.2; 1.3; 1.4; 1.5; 1.6; 1.7; 1.8; 1.9; 2; 2.1; 2.2; 2.3; 2.4; 2.5; 2.6; 2.7; 2.8; 2.9; 3; 3.1; 3.2; 3.3; 3.4; 3.5; 3.6; 3.7; 3.8; 3.9; 4; 4.1; 4.2; 4.3; 4.4; 4.5; 4.6; 4.7; 4.8; 4.9; 5; 5.1; 5.2; 5.3; 5.4; 5.5; 5.6; 5.7; 5.8; 5.9; 6; 6.1; 6.2; 6.3; 6.4; 6.5; 6.6; 6.7; 6.8; 6.9; 7; 7.1; 7.2; 7.3; 7.4; 7.5; 7.6; 7.7; 7.8; 7.9; 8; 8.1; 8.2; 8.3; 8.4; 8.5; 8.6; 8.7; 8.8; 8.9; 9; 9.1; 9.2; 9.3; 9.4; 9.5; 9.6; 9.7; 9.8; 9.9 or 10.

It is particularly preferred that the adhesion pad has a thickness of 0.5 mm +/−0.1 mm.

According to a preferred embodiment said modified surface of an adhesion pad is a surface comprising an increased adhesion to either (i) an orthodontic aligner or (ii) a surface of a tooth. Preferably, said modification is selected from at least the group comprising (a) measures to increase the friction coefficient of the surface, and/or (b) measures to furnish said surface with a micro or macro profile.

With regard to alternative (a), preferred alternatives are the selection of materials which upon getting in contact with the respective other material (tooth or aligner) yield a suitable friction coefficient, or the modification of a given material in order to thus yield a suitable friction coefficient upon getting in contact with the respective other material (tooth or aligner).

The friction coefficient, also termed “friction factor” (formula symbol t or also f, no dimension) is a measure for the friction force in relation to the contact pressure between two bodies. When determining a friction coefficient, kinetic (sliding) friction and static (adhesion) friction is being distinguished: with kinetic friction, the friction surfaces are moving relative to each other, whereas with static friction, they do not. In the case of Coulomb friction, the skid number is constant. In practice, respective temperature, speed and pressure dependencies have to be taken into account, which indicate an impact of the surface modification and the consistency of the surface which is never ideally flat (but which do not indicate the friction coefficient itself) and which seem to influence the properties of the materials.

The friction coefficient of metals is being measured with polished surfaces in order to largely exclude a mechanical gearing (form closure). Adhesion and cohesion forces between the materials are decisive factors. Depending upon the materials, Van-der-Waals forces or in polarized materials hydrogen-bond-like forces arise between the surfaces.

It is preferred that the material in contact with the respective other material (tooth or aligner) features a friction coefficient (static friction) of ≧0.1; ≧0.2; ≧0.3; ≧0.4; ≧0.5; ≧0.6; ≧0.7; ≧0.8; ≧0.9; ≧1; ≧1.1; ≧1.2; ≧1.3; ≧1.4; ≧1.5; ≧1.6; ≧1.7; ≧1.8; ≧1.9; ≧2; ≧2.1; ≧2.2; ≧2.3; ≧2.4; ≧2.5; ≧2.6; ≧2.7; ≧2.8; ≧2.9 or ≧3.

With regard to alternative (b), preferred alternatives are modifications of a given surface, either to modify the surface composition, or to generate a pattern with a corresponding kind of profile and/or a depth of profile.

In general, this can be achieved by creating a certain level of roughness. Roughness is a term used in surface physics for describing the unevenness of surface heights. Different calculation methods exist for quantitative characterization of roughness, which consider different features of the surfaces, respectively. The roughness of surfaces can be influenced, inter alia, by polishing, grinding, lapping, honing, bating, sandblasting, etching, vapor deposition or corrosion. The roughness of a technical surface is specified within the surface specifications of a technical drawing.

Roughness is especially important in technical fields, for example with technical sliding or visible surfaces. Available measuring instruments can be divided in three categories: manual methods, such as the “Rugotest”, profile-based methods such as methods using stylus instruments, and surface-based methods such as optical laminar measurement methods.

In principle, three different measures of roughness are used, which are given in the unit “μm”. The mean roughness, depicted by the symbol Rₐ, is the mean distance of a measuring point—on the surface—from the center line. The center line cuts the actual profile over a defined reference distance in such a way that the sum of all profile deviations (as referred to the center line) is reaching a minimum. The mean roughness corresponds to the arithmetric mean value of the deviations from the center line.

The so-called square roughness (rms-roughness=root-mean-squared roughness) is being calculated from the mean of the squares of all deviations.

The so-called averaged roughness depth (also called ten-point-height), depicted by the symbol Rₐ, can be determined as follows: a defined reference line or distance on the surface of a material is divided into seven equally long individual measuring lines. The analysis, however, is done only including five of these measuring lines, as the appropriate Gauβ filter requires one half of an individual measuring line advance and lag run, and as a folding is associated with running-in and running-out behaviors not to be underestimated. For each of these individual measuring lines of the profile, the difference between maximum and minimum value is being determined. Then the mean value of the five individual roughness depths obtained is being calculated.

It is preferred that said modified surface comprises a mean roughness (in μm) of ≧2; ≧3; ≧4; ≧5; ≧6; ≧7; ≧8; ≧9; ≧10; ≧11; ≧12; ≧13; ≧14; ≧15; ≧16; ≧17; ≧18; ≧19; ≧20; ≧21; ≧22; ≧23; ≧24; ≧25; ≧26; ≧27; ≧28; ≧29; ≧30; ≧31; ≧32; ≧33; ≧34; ≧35; ≧36; ≧37; ≧38; ≧39; ≧40; ≧41; ≧42; ≧43; ≧44; ≧45; ≧46; ≧47; ≧48; ≧49; ≧50; ≧51; ≧52; ≧53; ≧54; ≧55; ≧56; ≧57; ≧58; ≧59; ≧60; ≧61; ≧62; ≧63; ≧64; ≧65; ≧66; ≧67; ≧68; ≧69; ≧70; ≧71; ≧72; ≧73; ≧74; ≧75; ≧76; ≧77; ≧78; ≧79; ≧80; ≧81; ≧82; ≧83; ≧84; ≧85; ≧86; ≧87; ≧88; ≧89; ≧90; ≧91; ≧92; ≧93; ≧94; ≧95; ≧96; ≧97; ≧98; ≧99; ≧100; ≧101; ≧102; ≧103; ≧104; ≧105; ≧106; ≧107; ≧108; ≧109; ≧110; ≧111; ≧112; ≧113; ≧114; ≧115; ≧116; ≧117; ≧118; ≧119; ≧120; ≧121; ≧122; ≧123; ≧124; ≧125; ≧126; ≧127; ≧128; ≧129; ≧130; ≧131; ≧132; ≧133; ≧134; ≧135; ≧136; ≧137; ≧138; ≧139; ≧140; ≧141; ≧142; ≧143; ≧144; ≧145; ≧146; ≧147; ≧148; ≧149; ≧150; ≧151; ≧152; ≧153; ≧154; ≧155; ≧156; ≧157; ≧158; ≧159; ≧160; ≧161; ≧162; ≧163; ≧164; ≧165; ≧166; ≧167; ≧168; ≧169; ≧170; ≧171; ≧172; ≧173; ≧174; ≧175; ≧176; ≧177; ≧178; ≧179; ≧180; ≧181; ≧182; ≧183; ≧184; ≧185; ≧186; ≧187; ≧188; ≧189; ≧190; ≧191; ≧192; ≧193; ≧194; ≧195; ≧196; ≧197; ≧198; ≧199; ≧200; ≧201; ≧202; ≧203; ≧204; ≧205; ≧206; ≧207; ≧208; ≧209; ≧210; ≧211; ≧212; ≧213; ≧214; ≧215; ≧216; ≧217; ≧218; ≧219; ≧220; ≧221; ≧222; ≧223; ≧224; ≧225; ≧226; ≧227; ≧228; ≧229; ≧230; ≧231; ≧232; ≧233; ≧234; ≧235; ≧236; ≧237; ≧238; ≧239; ≧240; ≧241; ≧242; ≧243; ≧244; ≧245; ≧246; ≧247; ≧248; ≧249; ≧250; ≧251; ≧252; ≧253; ≧254; ≧255; ≧256; ≧257; ≧258; ≧259; ≧260; ≧261; ≧262; ≧263; ≧264; ≧265; ≧266; ≧267; ≧268; ≧269; ≧270; ≧271; ≧272; ≧273; ≧274; ≧275; ≧276; ≧277; ≧278; ≧279; ≧280; ≧281; ≧282; ≧283; ≧284; ≧285; ≧286; ≧287; ≧288; ≧289; ≧290; ≧291; ≧292; ≧293; ≧294; ≧295; ≧296; ≧297; ≧298; ≧299; ≧300; ≧301; ≧302; ≧303; ≧304; ≧305; ≧306; ≧307; ≧308; ≧309; ≧310; ≧311; ≧312; ≧313; ≧314; ≧315; ≧316; ≧317; ≧318; ≧319; ≧320; ≧321; ≧322; ≧323; ≧324; ≧325; ≧326; ≧327; ≧328; ≧329; ≧330; ≧331; ≧332; ≧333; ≧334; ≧335; ≧336; ≧337; ≧338; ≧339; ≧340; ≧341; ≧342; ≧343; ≧344; ≧345; ≧346; ≧347; ≧348; ≧349; ≧350; ≧351; ≧352; ≧353; ≧354; ≧355; ≧356; ≧357; ≧358; ≧359; ≧360; ≧361; ≧362; ≧363; ≧364; ≧365; ≧366; ≧367; ≧368; ≧369; ≧370; ≧371; ≧372; ≧373; ≧374; ≧375; ≧376; ≧377; ≧378; ≧379; ≧380; ≧381; ≧382; ≧383; ≧384; ≧385; ≧386; ≧387; ≧388; ≧389; ≧390; ≧391; ≧392; ≧393; ≧394; ≧395; ≧396; ≧397; ≧398; ≧399; ≧400; ≧401; ≧402; ≧403; ≧404; ≧405; ≧406; ≧407; ≧408; ≧409; ≧410; ≧411; ≧412; ≧413; ≧414; ≧415; ≧416; ≧417; ≧418; ≧419; ≧420; ≧421; ≧422; ≧423; ≧424; ≧425; ≧426; ≧427; ≧428; ≧429; ≧430; ≧431; ≧432; ≧433; ≧434; ≧435; ≧436; ≧437; ≧438; ≧439; ≧440; ≧441; ≧442; ≧443; ≧444; ≧445; ≧446; ≧447; ≧448; ≧449; ≧450; ≧451; ≧452; ≧453; ≧454; ≧455; ≧456; ≧457; ≧458; ≧459; ≧460; ≧461; ≧462; ≧463; ≧464; ≧465; ≧466; ≧467; ≧468; ≧469; ≧470; ≧471; ≧472; ≧473; ≧474; ≧475; ≧476; ≧477; ≧478; ≧479; ≧480; ≧481; ≧482; ≧483; ≧484; ≧485; ≧486; ≧487; ≧488; ≧489; ≧490; ≧491; ≧492; ≧493; ≧494; ≧495; ≧496; ≧497; ≧498; ≧499; ≧500; ≧501; ≧502; ≧503; ≧504; ≧505; ≧506; ≧507; ≧508; ≧509; ≧510; ≧511; ≧512; ≧513; ≧514; ≧515; ≧516; ≧517; ≧518; ≧519; ≧520; ≧521; ≧522; ≧523; ≧524; ≧525; ≧526; ≧527; ≧528; ≧529; ≧530; ≧531; ≧532; ≧533; ≧534; ≧535; ≧536; ≧537; ≧538; ≧539; ≧540; ≧541; ≧542; ≧543; ≧544; ≧545; ≧546; ≧547; ≧548; ≧549; ≧550; ≧551; ≧552; ≧553; ≧554; ≧555; ≧556; ≧557; ≧558; ≧559; ≧560; ≧561; ≧562; ≧563; ≧564; ≧565; ≧566; ≧567; ≧568; ≧569; ≧570; ≧571; ≧572; ≧573; ≧574; ≧575; ≧576; ≧577; ≧578; ≧579; ≧580; ≧581; ≧582; ≧583; ≧584; ≧585; ≧586; ≧587; ≧588; ≧589; ≧590; ≧591; ≧592; ≧593; ≧594; ≧595; ≧596; ≧597; ≧598; ≧599; ≧600; ≧601; ≧602; ≧603; ≧604; ≧605; ≧606; ≧607; ≧608; ≧609; ≧610; ≧611; ≧612; ≧613; ≧614; ≧615; ≧616; ≧617; ≧618; ≧619; ≧620; ≧621; ≧622; ≧623; ≧624; ≧625; ≧626; ≧627; ≧628; ≧629; ≧630; ≧631; ≧632; ≧633; ≧634; ≧635; ≧636; ≧637; ≧638; ≧639; ≧640; ≧641; ≧642; ≧643; ≧644; ≧645; ≧646; ≧647; ≧648; ≧649; ≧650; ≧651; ≧652; ≧653; ≧654; ≧655; ≧656; ≧657; ≧658; ≧659; ≧660; ≧661; ≧662; ≧663; ≧664; ≧665; ≧666; ≧667; ≧668; ≧669; ≧670; ≧671; ≧672; ≧673; ≧674; ≧675; ≧676; ≧677; ≧678; ≧679; ≧680; ≧681; ≧682; ≧683; ≧684; ≧685; ≧686; ≧687; ≧688; ≧689; ≧690; ≧691; ≧692; ≧693; ≧694; ≧695; ≧696; ≧697; ≧698; ≧699; ≧700; ≧701; ≧702; ≧703; ≧704; ≧705; ≧706; ≧707; ≧708; ≧709; ≧710; ≧711; ≧712; ≧713; ≧714; ≧715; ≧716; ≧717; ≧718; ≧719; ≧720; ≧721; ≧722; ≧723; ≧724; ≧725; ≧726; ≧727; ≧728; ≧729; ≧730; ≧731; ≧732; ≧733; ≧734; ≧735; ≧736; ≧737; ≧738; ≧739; ≧740; ≧741; ≧742; ≧743; ≧744; ≧745; ≧746; ≧747; ≧748; ≧749; ≧750; ≧751; ≧752; ≧753; ≧754; ≧755; ≧756; ≧757; ≧758; ≧759; ≧760; ≧761; ≧762; ≧763; ≧764; ≧765; ≧766; ≧767; ≧768; ≧769; ≧770; ≧771; ≧772; ≧773; ≧774; ≧775; ≧776; ≧777; ≧778; ≧779; ≧780; ≧781; ≧782; ≧783; ≧784; ≧785; ≧786; ≧787; ≧788; ≧789; ≧790; ≧791; ≧792; ≧793; ≧794; ≧795; ≧796; ≧797; ≧798; ≧799; ≧800; ≧801; ≧802; ≧803; ≧804; ≧805; ≧806; ≧807; ≧808; ≧809; ≧810; ≧811; ≧812; ≧813; ≧814; ≧815; ≧816; ≧817; ≧818; ≧819; ≧820; ≧821; ≧822; ≧823; ≧824; ≧825; ≧826; ≧827; ≧828; ≧829; ≧830; ≧831; ≧832; ≧833; ≧834; ≧835; ≧836; ≧837; ≧838; ≧839; ≧840; ≧841; ≧842; ≧843; ≧844; ≧845; ≧846; ≧847; ≧848; ≧849; ≧850; ≧851; ≧852; ≧853; ≧854; ≧855; ≧856; ≧857; ≧858; ≧859; ≧860; ≧861; ≧862; ≧863; ≧864; ≧865; ≧866; ≧867; ≧868; ≧869; ≧870; ≧871; ≧872; ≧873; ≧874; ≧875; ≧876; ≧877; ≧878; ≧879; ≧880; ≧881; ≧882; ≧883; ≧884; ≧885; ≧886; ≧887; ≧888; ≧889; ≧890; ≧891; ≧892; ≧893; ≧894; ≧895; ≧896; ≧897; ≧898; ≧899; ≧900; ≧901; ≧902; ≧903; ≧904; ≧905; ≧906; ≧907; ≧908; ≧909; ≧910; ≧911; ≧912; ≧913; ≧914; ≧915; ≧916; ≧917; ≧918; ≧919; ≧920; ≧921; ≧922; ≧923; ≧924; ≧925; ≧926; ≧927; ≧928; ≧929; ≧930; ≧931; ≧932; ≧933; ≧934; ≧935; ≧936; ≧937; ≧938; ≧939; ≧940; ≧941; ≧942; ≧943; ≧944; ≧945; ≧946; ≧947; ≧948; ≧949; ≧950; ≧951; ≧952; ≧953; ≧954; ≧955; ≧956; ≧957; ≧958; ≧959; ≧960; ≧961; ≧962; ≧963; ≧964; ≧965; ≧966; ≧967; ≧968; ≧969; ≧970; ≧971; ≧972; ≧973; ≧974; ≧975; ≧976; ≧977; ≧978; ≧979; ≧980; ≧981; ≧982; ≧983; ≧984; ≧985; ≧986; ≧987; ≧988; ≧989; ≧990; ≧991; ≧992; ≧993; ≧994; ≧995; ≧996; ≧997; ≧998; ≧999; ≧1000.

According to another embodiment of the present invention a process for production of adhesion pads is provided, wherein the process comprises the following steps:

a) Determining the region of one tooth or several teeth, or of an aligner, where the adhesion pad shall be mounted, and

b) Producing an adhesion pad.

Preferably said process comprises a step of generating a virtual CAD model, representing said adhesion pad, wherein said CAD model optionally comprises at least on one side a micro or macro profile which is suited for increasing adhesion of the same to the surface of a tooth or to an aligner.

As used herein, the term “CAD model” shall refer to an object being generated by computer-aided design (CAD). This method comprises the use of the computer system for assisting in generation, modification, analysis, or optimization of the model. Computer-aided design means the process of generating a technical drawing by use of computer programs (CAD programs). The CAD program employs either vector-based graphics to depict the objects in a traditional drawing, or it can generate raster graphics depicting the entire appearance of the modelled object.

The micro or macro profile can be generated either by inserting a picture file, such as, e.g., a bmp file, into the CAD system, or by virtual creation of a profile with the CAD program.

According to another preferred embodiment of the present invention said process comprises an additional step by which said virtual CAD model of an adhesion pad is virtually mounted onto the surface of a virtual CAD model representing one target tooth or several target teeth or an entire jaw. This is done by positioning the virtual CAD model of the adhesion pad at the surface of said virtual model of one target tooth or several target teeth or of the entire jaw.

Subsequently, for example a positive model of one or several target teeth or an entire jaw with one or more adhesion pads mounted onto them can be generated, e.g., by 3D printing. Based on this model, an aligner or a transfer tray can then be produced, e.g., by deep drawing on said positive model.

In this embodiment said aligner comprises one or more cavities whose dimensions and positioning correspond to those adhesion pads mounted onto or to be mounted onto the tooth or the teeth, respectively.

For use of such an aligner, therefore, adhesion pads mountable onto teeth are required which then when the aligner is being carried fit into said corresponding cavities after the aligner has been put over the adhesion pad. Thus a tight fit and an efficient force transfer can be granted.

The term “transfer tray”, as used herein, refers to an object similar to an aligner which, however, is not being used as an instrument for correcting dental position, but only for adequately positioning adhesion pads to be mounted onto the teeth at the correct location. For this purpose, said adhesion pads are fitted into the cavities. Then the transfer tray is brought to the target tooth or teeth or the entire jaw, respectively. Said adhesion pads can then be mounted, for example by use of a glue which has been applied to them before (e.g., a light-hardening glue), onto the target tooth or teeth, respectively. Alternatively, said cavities can be filled with a hardening material which is hardened after mounting the transfer tray onto the target tooth or teeth or the entire jaw, respectively, at the final position (e.g., by light), in order to form and position the mountable adhesion pads at the correct place in one step.

According to another preferred embodiment of the present invention, said process comprises another step by which the negative form of said virtual CAD model of an adhesion pad is virtually placed onto the surface of a virtual CAD model representing one target tooth or several target teeth or the entire jaw. Hereby it is provided that the virtual CAD model representing the adhesion pad creates a cavity embedded in the surface of the virtual CAD model of the target tooth or teeth or the entire jaw, respectively, and that said cavity takes on the form and/or surface profile of the adhesion pad.

In this case, a positive model of one or more target teeth or the entire jaw is produced featuring one or more cavities embedded in its surface. Such model can be produced, for example, by 3D printing. Subsequently, an aligner can be generated based on this positive model, e.g., by deep drawing. Said aligner will thus encompass integrated adhesion pads. For use with the patient, hence no adhesion pads mountable to teeth or aligner are required.

According to still another preferred embodiment of the present invention, said process comprises another step by which said virtual CAD model of an adhesion pad is virtually placed onto the inner surface of a virtual CAD model representing an orthodontic aligner. Hereby it is provided that the virtual CAD model representing the adhesion pad is positioned at the inner surface of said virtual model of an orthodontic aligner.

In this case, an aligner with integrated adhesion pads can be produced directly, e.g., by 3D plotting. Then it is not required any more to make a detour via a positive model and a deep drawing step.

Alternatively, the adhesion pad can also be generated directly with a tooth model.

Thus the process according to another preferred embodiment encompasses an alternative step whereby an adhesion pad can be directly molded on a tooth model. In this case no separate CAD model has to be designed. The step of attaching the adhesion pad to a tooth model can also be spared that way.

According to another preferred embodiment of the present invention, the virtual CAD model representing one or more target teeth or an entire jaw is generated by 3D scan of a cast, which cast has been produced by casting of a target tooth, of several target teeth, or of the entire jaw of a patient using a suitable material.

Usually such casting is performed by use of an impression tray, the so-called “rimlock”, which is filled with, e.g., an alginate filling. After hardening of the cast (negative model), said cast is being grouted by gypsum or other suitable materials in order to yield a complimentary cast and thus a positive model. The person skilled in the art will be aware of further kinds of impression trays which also can be used in the context of the present invention.

In a further embodiment, the 3D scan can also be generated using an intraoral scanner/3D camera directly in a patient's mouth. Thereby the 3D model of the jaw can be produced without the need of preparing a cast.

According to another particular, preferred embodiment, the present invention comprises a process step for generating

(a) at least one physical model of an adhesion pad,

(b) one or more physical models of one target tooth, or of several target teeth, or of the entire jaw, which are comprising at least a model of an adhesion pad attached to their surfaces, and/or

(c) one or more physical models of one target tooth, or of several target teeth, or of the entire jaw, comprising cavities embedded in their surfaces, wherein said cavities take on the form and/or the surface profile of the adhesion pad on basis of the respective virtual CAD models and using a CAM methodology.

As used herein, the term “CAM” relates to the so-called computer aided manufacturing, wherein a computer operates a manufacturing machine. CAM processes include the so-called “Rapid Prototyping”, such as 3D plotting, 3D photolithography, or CNC milling. CAM processes are usually combined with CAD technology (so-called “CAD/CAM”).

In an alternative embodiment, adhesion pads for one or more target teeth or the entire jaw are being produced according to the method of the present invention as described above and mounted to the teeth. An aligner supposed to exert its effect via these adhesion pads can be produced in an alternative embodiment using a positive model which does not feature adhesion pads and optionally can be provided in a partly smaller form such that an aligner produced therewith can be attached to a positive model not decreased in size and/or teeth of patients which are equipped with at least one adhesion pad.

For example, a positive model of one target tooth, several target teeth or an entire jaw (without adhesion pads) can be produced, e.g., by 3D printing. Based on this model, an aligner can be generated, e.g., by deep drawing using said positive model.

According to another embodiment of the present invention, a process for production of an aligner for use in combination with an adhesion pad according to the present invention is provided. This method comprises a step for production of one or more physical models of one target tooth, or several target teeth, or an entire jaw without adhesion pads mounted to them on the basis of a virtual model of one target tooth, or several target teeth, or an entire jaw. CAM technology is used for this purpose.

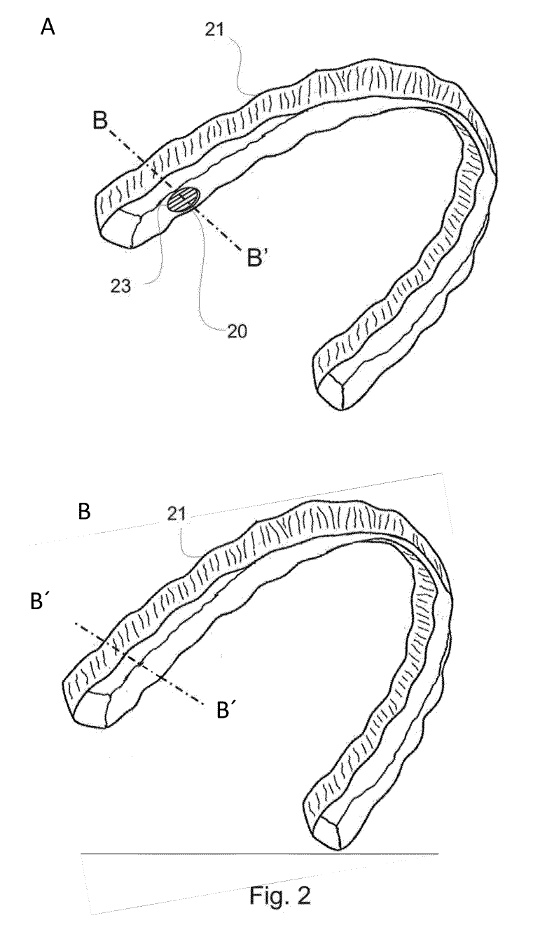

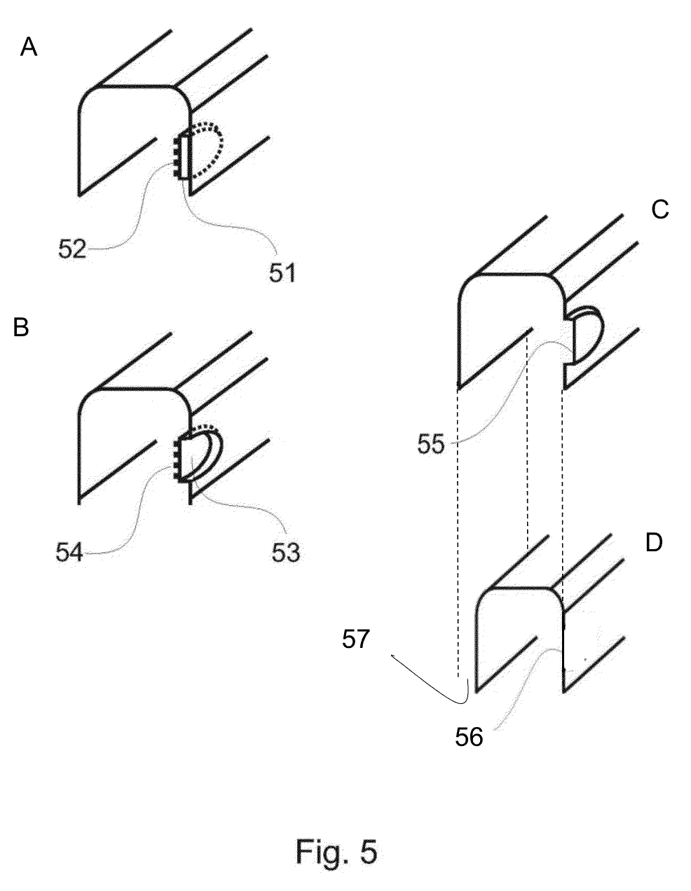

In this context, it is also referred to Example 1 of the present invention, as well as FIG. 2B where aligners without cavities for adhesion pads are depicted. An alternative embodiment is depicted in FIG. 5D, where the aligner of FIG. 2B is shown in reduced scale.

According to another embodiment of the present invention, a process for production of one or more orthodontic aligners is provided wherein said aligners are produced by deep drawing over a physical model of one target tooth, or several target teeth, or the entire jaw. Said model is produced thereby with a method according to said embodiment above, alternative b).

According to yet another embodiment of the present invention, a process is provided for production of one or more transfer trays, wherein said transfer trays are produced by deep drawing over a physical model of one target tooth, or several target teeth, or the entire jaw. Said model is produced thereby with a method according to said embodiment above, alternative b).

Alternatively, transfer trays can be produced by use of casting materials such as silicones.

As used herein, the term “transfer tray” relates to an object similar to an aligner which, however, is not being used as an instrument for correcting dental position, but only for adequately positioning adhesion pads to be mounted onto the teeth at the correct location. For this purpose, said adhesion pads are fitted into the cavities. Then the transfer tray is brought to the target tooth or teeth or the entire jaw, respectively. Said adhesion pads can then be mounted, for example by use of a glue which has been applied to them before (e.g., a light-hardening glue), onto the target tooth or teeth, respectively. Alternatively, said cavities can be filled with a hardening material which is hardened after mounting the transfer tray onto the target tooth or teeth or the entire jaw, respectively, at the final position (e.g., by light), in order to form and position the mountable adhesion pads at the correct place in one step.

According to a preferred embodiment of the present invention, in the virtual CAD model representing a target tooth or target teeth or an entire jaw the position of one or more teeth is being manipulated by hand or by a given algorithm. In a particularly preferred embodiment, the position of at least one tooth in the virtual CAD model is modified by said manipulation.

The aim of such manipulation is to simulate a particular correction of the position of one tooth or of several teeth in the context of a therapy plan. Thereby said teeth shall be brought into a medically or esthetically desired position.

According to another preferred embodiment of the present invention, said manipulation of the virtual CAD model serves for creation of one or several transitional dental positions, and optionally also for creation of a preliminary or final target teeth position.

With this embodiment, a therapy plan is thus simulated which aims at the correction of positions with regard to one tooth or several teeth. Thereby said teeth shall be brought into a medically or esthetically desired position. To this end, one or several transitional dental positions are simulated which occur during movements of said one or several teeth in the course of the therapy plan. With other words: the required movement is divided in several intervals, and the dental positions corresponding to said intervals are simulated in the virtual model.

Preferably said manipulation of the virtual CAD model representing one target tooth, several target teeth or the entire jaw is used for production of one or several orthodontic aligners.

For example, a set of different aligners having different forms can be generated. This is useful, e.g., in the context of an orthodontic therapy plan, wherein the position of one or several teeth is stepwise corrected by employing correcting or stabilizing forces onto said teeth, in order to stepwise achieve a final medically or esthetically desired position of the teeth. Thereby the first aligner defines an initial transitional dental position and the last aligner defines a preliminary or final target position of the teeth which is desired to be achieved by use of the therapy plan. The number of intervals, corresponding to the number of transitional aligners produced, can be chosen according to the medical needs.

According to another embodiment of the present invention an orthodontic aligner is provided which comprises at least one aligner-integrated adhesion pad, wherein said aligner is being produced by a method according to the description above.

According to another embodiment of the present invention a transfer tray is provided comprising at least one cavity suited for reception of at least one adhesion pad mounted to a tooth, or suited for reception of a material capable to polymerize, wherein said transfer tray is being produced by a method according to the description above.

According to another embodiment of the present invention a set of two or more orthodontic aligners is provided which are produced by a method according to the requirements described above, wherein the different aligners of said set vary in their form among one another.

For example, the different aligners can be used in an orthodontic therapy plan which is implemented in order to stepwise correct the position of one tooth or more teeth. Thereby the first aligner defines an initial transitional dental position and the last aligner defines a preliminary or final target position of the teeth which is desired to be achieved by use of the therapy plan.

According to another embodiment of the present invention a process for production of an orthodontic aligner is provided comprising an improved transmission of correcting or stabilizing forces onto one tooth, or several teeth, or on the entire jaw of a patient. Said process comprises the following steps:

(a) production of a physical model of one target tooth or several target teeth or the entire jaw, wherein the model is reduced in size as compared to the target teeth or the entire jaw of the patient, respectively, and

(b) production of an orthodontic aligner based on this model by, e.g., deep drawing.

With an alternative embodiment, step (a) comprises production of a physical model of one target tooth or several target teeth or the entire jaw, wherein the model corresponds in size to the target teeth or the entire jaw of the patient, respectively.

With a preferred embodiment, the produced aligner comprises at least in part a layer composed of elastic material. Particularly preferred is a thickness of the layer of 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2,0, 2.1, 2.2, 2.3, 2.3, 2.4, 2.5, 2.6, 2.7, 2.8, 2.9 or 3.0 mm.

Thereby a model can be generated that serves as template for production of one or more aligners which tightly fit over one target tooth or several target teeth or the entire jaw of the patient, respectively. By said aligner being slightly smaller than one target tooth or several target teeth or the entire jaw of the patient, respectively, an efficient transmission of correcting or stabilizing forces exerted by the aligner onto the target tooth or the target teeth, respectively, is achieved.

Preferably it is provided that the physical model of one target tooth or several target teeth or the entire jaw is reduced in size along at least one of the three Cartesian axes of the three-dimensional coordinate system by a value of between ≧0.01% and ≦20% as compared to the target teeth or the entire jaw of the patient, respectively.

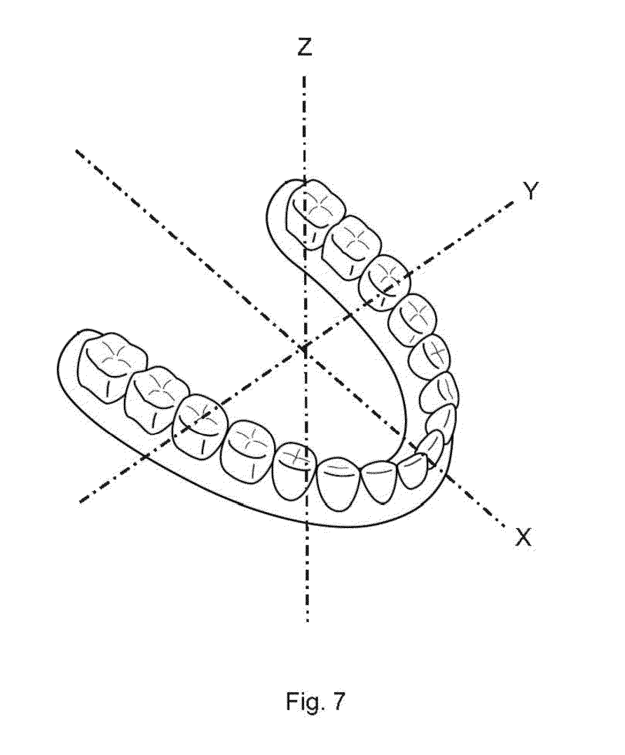

A Cartesian coordinate system for a three-dimensional area consists of a triplet of axes, wherein two axes each form a right angle with each other. Often these axes are termed x, y and z axes, as for example shown in FIG. 7.

Preferably said physical model is reduced in size along at least one of the three Cartesian axes by a percentage of 0.01. 0.04; 0.07; 0.1; 0.13; 0.16; 0.19; 0.22; 0.25; 0.28; 0.31; 0.34; 0.37; 0.4; 0.43; 0.46; 0.49; 0.52; 0.55; 0.58; 0.61; 0.64; 0.67; 0.7; 0.73; 0.76; 0.79; 0.82; 0.85; 0.88; 0.91; 0.94; 0.97; 1; 1.03; 1.06; 1.09; 1.12; 1.15; 1.18; 1.21; 1.24; 1.27; 1.3; 1.33; 1.36; 1.39; 1.42; 1.45; 1.48; 1.51; 1.54; 1.57; 1.6; 1.63; 1.66; 1.69; 1.72; 1.75; 1.78; 1.81; 1.84; 1.87; 1.9; 1.93; 1.96; 1.99; 2.02; 2.05; 2.08; 2.11; 2.14; 2.17; 2.2; 2.23; 2.26; 2.29; 2.32; 2.35; 2.38; 2.41; 2.44; 2.47; 2.5; 2.53; 2.56; 2.59; 2.62; 2.65; 2.68; 2.71; 2.74; 2.77; 2.8; 2.83; 2.86; 2.89; 2.92; 2.95; 2.98; 3.01; 3.04; 3.07; 3.1; 3.13; 3.16; 3.19; 3.22; 3.25; 3.28; 3.31; 3.34; 3.37; 3.4; 3.43; 3.46; 3.49; 3.52; 3.55; 3.58; 3.61; 3.64; 3.67; 3.7; 3.73; 3.76; 3.79; 3.82; 3.85; 3.88; 3.91; 3.94; 3.97; 4; 4.03; 4.06; 4.09; 4.12; 4.15; 4.18; 4.21; 4.24; 4.27; 4.3; 4.33; 4.36; 4.39; 4.42; 4.45; 4.48; 4.51; 4.54; 4.57; 4.6; 4.63; 4.66; 4.69; 4.72; 4.75; 4.78; 4.81; 4.84; 4.87; 4.9; 4.93; 4.96; 4.99; 5.02; 5.05; 5.08; 5.11; 5.14; 5.17; 5.2; 5.23; 5.26; 5.29; 5.32; 5.35; 5.38; 5.41; 5.44; 5.47; 5.5; 5.53; 5.56; 5.59; 5.62; 5.65; 5.68; 5.71; 5.74; 5.77; 5.8; 5.83; 5.86; 5.89; 5.92; 5.95; 5.98; 6.01; 6.04; 6.07; 6.1; 6.13; 6.16; 6.19; 6.22; 6.25; 6.28; 6.31; 6.34; 6.37; 6.4; 6.43; 6.46; 6.49; 6.52; 6.55; 6.58; 6.61; 6.64; 6.67; 6.7; 6.73; 6.76; 6.79; 6.82; 6.85; 6.88; 6.91; 6.94; 6.97; 7; 7.03; 7.06; 7.09; 7.12; 7.15; 7.18; 7.21; 7.24; 7.27; 7.3; 7.33; 7.36; 7.39; 7.42; 7.45; 7.48; 7.51; 7.54; 7.57; 7.6; 7.63; 7.66; 7.69; 7.72; 7.75; 7.78; 7.81; 7.84; 7.87; 7.9; 7.93; 7.96; 7.99; 8.02; 8.05; 8.08; 8.11; 8.14; 8.17; 8.2; 8.23; 8.26; 8.29; 8.32; 8.35; 8.38; 8.41; 8.44; 8.47; 8.5; 8.53; 8.56; 8.59; 8.62; 8.65; 8.68; 8.71; 8.74; 8.77; 8.8; 8.83; 8.86; 8.89; 8.92; 8.95; 8.98; 9.01; 9.04; 9.07; 9.1; 9.13; 9.16; 9.19; 9.22; 9.25; 9.28; 9.31; 9.34; 9.37; 9.4; 9.43; 9.46; 9.49; 9.52; 9.55; 9.58; 9.61; 9.64; 9.67; 9.7; 9.73; 9.76; 9.79; 9.82; 9.85; 9.88; 9.91; 9.94; 9.97; 10; 10.03; 10.06; 10.09; 10.12; 10.15; 10.18; 10.21; 10.24; 10.27; 10.3; 10.33; 10.36; 10.39; 10.42; 10.45; 10.48; 10.51; 10.54; 10.57; 10.6; 10.63; 10.66; 10.69; 10.72; 10.75; 10.78; 10.81; 10.84; 10.87; 10.9; 10.93; 10.96; 10.99; 11.02; 11.05; 11.08; 11.11; 11.14; 11.17; 11.2; 11.23; 11.26; 11.29; 11.32; 11.35; 11.38; 11.41; 11.44; 11.47; 11.5; 11.53; 11.56; 11.59; 11.62; 11.65; 11.68; 11.71; 11.74; 11.77; 11.8; 11.83; 11.86; 11.89; 11.92; 11.95; 11.98; 12.01; 12.04; 12.07; 12.1; 12.13; 12.16; 12.19; 12.22; 12.25; 12.28; 12.31; 12.34; 12.37; 12.4; 12.43; 12.46; 12.49; 12.52; 12.55; 12.58; 12.61; 12.64; 12.67; 12.7; 12.73; 12.76; 12.79; 12.82; 12.85; 12.88; 12.91; 12.94; 12.97; 13; 13.03; 13.06; 13.09; 13.12; 13.15; 13.18; 13.21; 13.24; 13.27; 13.3; 13.33; 13.36; 13.39; 13.42; 13.45; 13.48; 13.51; 13.54; 13.57; 13.6; 13.63; 13.66; 13.69; 13.72; 13.75; 13.78; 13.81; 13.84; 13.87; 13.9; 13.93; 13.96; 13.99; 14.02; 14.05; 14.08; 14.11; 14.14; 14.17; 14.2; 14.23; 14.26; 14.29; 14.32; 14.35; 14.38; 14.41; 14.44; 14.47; 14.5; 14.53; 14.56; 14.59; 14.62; 14.65; 14.68; 14.71; 14.74; 14.77; 14.8; 14.83; 14.86; 14.89; 14.92; 14.95; 14.98; 15.01; 15.04; 15.07; 15.1; 15.13; 15.16; 15.19; 15.22; 15.25; 15.28; 15.31; 15.34; 15.37; 15.4; 15.43; 15.46; 15.49; 15.52; 15.55; 15.58; 15.61; 15.64; 15.67; 15.7; 15.73; 15.76; 15.79; 15.82; 15.85; 15.88; 15.91; 15.94; 15.97; 16; 16.03; 16.06; 16.09; 16.12; 16.15; 16.18; 16.21; 16.24; 16.27; 16.3; 16.33; 16.36; 16.39; 16.42; 16.45; 16.48; 16.51; 16.54; 16.57; 16.6; 16.63; 16.66; 16.69; 16.72; 16.75; 16.78; 16.81; 16.84; 16.87; 16.9; 16.93; 16.96; 16.99; 17.02; 17.05; 17.08; 17.11; 17.14; 17.17; 17.2; 17.23; 17.26; 17.29; 17.32; 17.35; 17.38; 17.41; 17.44; 17.47; 17.5; 17.53; 17.56; 17.59; 17.62; 17.65; 17.68; 17.71; 17.74; 17.77; 17.8; 17.83; 17.86; 17.89; 17.92; 17.95; 17.98; 18.01; 18.04; 18.07; 18.1; 18.13; 18.16; 18.19; 18.22; 18.25; 18.28; 18.31; 18.34; 18.37; 18.4; 18.43; 18.46; 18.49; 18.52; 18.55; 18.58; 18.61; 18.64; 18.67; 18.7; 18.73; 18.76; 18.79; 18.82; 18.85; 18.88; 18.91; 18.94; 18.97; 19; 19.03; 19.06; 19.09; 19.12; 19.15; 19.18; 19.21; 19.24; 19.27; 19.3; 19.33; 19.36; 19.39; 19.42; 19.45; 19.48; 19.51; 19.54; 19.57; 19.6; 19.63; 19.66; 19.69; 19.72; 19.75; 19.78; 19.81; 19.84; 19.87; 19.9; 19.93; 19.96 or 20%.

It is particularly preferred that the physical model reduced in size of one target tooth or several target teeth or the entire jaw is produced by

(a) Generating a 3D scan of a cast (=positive model) which has been produced based on a cast (=negative model) of one target tooth or several target teeth or the entire jaw of a patient using a suitable material,

b) Generating a virtual CAD model representing one target tooth or several target teeth or the entire jaw of a patient,

(c) Optionally: Reducing said virtual CAD model in size, and

(d) Generating a physical model reduced in size of said virtual CAD model by use of CAM technology.

In another preferred embodiment, the 3D scan can also be generated within the mouth of a patient.

Feature C of said method is optional, because the reduction step can also be an integral part of the step of producing the physical model reduced in size, as an alternative to reducing said virtual CAD model. As an example, it can be provided that the virtual CAD model is not reduced on the screen (but potentially dental positioning might be modified on the screen as described), and that, for example, during the step of production by CAM technology a 3D-printing printing order is sent to a 3D-plotter, wherein said 3D-printing order already comprises the size reduction factor, as described above, or is received by the 3D-plotter with a respective reduction factor.

According to another preferred embodiment of the present invention the virtual CAD model representing one tooth or several teeth or the entire jaw of a patient is being manipulated, either before or after size reduction, by a person or by a given algorithm.

Preferably the position of at least one tooth in the virtual CAD model is reduced in size by said manipulation. Such manipulation aims at simulating a particular positional correction with regard to one tooth or several teeth in the context of a therapy plan. Thereby said teeth are intended to be brought into a medically or esthetically desired position.

In another preferred alternative embodiment with regard to feature C one target tooth or several target teeth can be generated enlarged in size by the method of the present invention, which works correspondingly to the reduction as described before.

Enlarging a virtual CAD model within one of the ranges of 0.01% to 4% mentioned above can also be an integral part of the step of generating the enlarged physical model. As an example, it can be provided that the virtual CAD model is not enlarged on the screen (but potentially dental positioning might be modified on the screen as described), and that, for example, during the step of production by CAM technology a 3D-printing order is sent to a 3D-plotter, wherein said 3D-printing order already comprises the size enlargement factor, as described above, or is received by the 3D-plotter with a respective enlargement factor.

According to another preferred embodiment of the present invention said manipulation of the virtual CAD model serves to generate one or several transitional dental positionings, and optionally also to generate a preliminary or final target teeth position.

With this embodiment, therefore, a therapy plan is being simulated, which aims at a positional correction regarding one tooth or several teeth. Thereby, said teeth are intended to be brought into a medically or esthetically desired position. To this end, one or several transitional dental positionings are simulated which occur during the ongoing dental movements in the course of the therapy plan. In other words: the necessary movement is being divided in various intervals, and the respective dental positions arising in said intervals are simulated in the virtual model.

According to another preferred embodiment of the present invention said manipulation of the virtual CAD model representing one target tooth or several target teeth or the entire jaw serves to produce one or several orthodontic aligners.

For example, a set of different aligners having different forms can be generated. This is useful, e.g., in the context of an orthodontic therapy plan, wherein the position of one or several teeth is stepwise corrected by employing correcting or stabilizing forces onto said teeth, in order to stepwise achieve a final medically or esthetically desired position of the teeth. Thereby the first aligner defines an initial transitional dental position and the last aligner defines a preliminary or final target position of the teeth which is desired to be achieved by use of the therapy plan. The number of intervals, corresponding to the number of transitional aligners produced, can be chosen according to the medical needs.

Furthermore, an orthodontic aligner is provided which has been produced by a method according to the present invention wherein said aligner is slightly smaller than one or several target teeth or the entire jaw of the patient.

Furthermore, a set of two or more orthodontic aligners is provided which are produced according to the method described above, wherein the different aligners of said set vary in their form among one another.

For example, the different aligners can be used in an orthodontic therapy plan which is implemented in order to stepwise correct the position of one or more teeth. Thereby the first aligner defines an initial transitional dental position and the last aligner defines a preliminary or final target position of the teeth which is desired to be achieved by use of the orthodontic therapy plan.

By said aligner or said aligners being slightly smaller than one target tooth or several target teeth or the entire jaw of the patient, respectively, an efficient transmission of correcting or stabilizing forces exerted by the aligner onto the target tooth or the target teeth, respectively, is achieved.

Furthermore, individual teeth can be virtually enlarged, so that a selective application of the force and thus movement (of the teeth which are not enlarged) can be achieved without also moving the enlarged teeth.

Alternatively, an aligner can be produced accurately fitting onto a virtual and/or physical positive model which does not comprise adhesion pad cavities. In a preferred embodiment said aligner comprises at least one partially elastic layer.

As shown in Example 1, an aligner without cavities can already increase the adhesion force in combination with adhesion pads attached to the teeth. Particularly good results have been achieved when the aligner comprises an at least partial layer composed of an elastic material.

According to the present invention, the respective embodiments can also be combined with each other. For example, an aligner can be provided comprising sections partially reduced as well as partially enlarged in size for some teeth or unmodified, i.e., accurately fitting and aligner-integrated or aligner-mounted adhesion pads. All other combinations of the embodiments described above are also comprised by the present invention.

In a particularly preferred embodiment the aligners at least partially reduced in size or the aligners which do not comprise cavities and which can be produced accurately fitting directly to a positive model, respectively, can be composed of an at least partially elastic aligner material.

According to the present invention, particularly deep-drawing films are being used as partially elastic aligner material that are composed of at least two phases and which are suited for the production of orthodontic aligners.

In a preferred embodiment, for the production of aligners at least following materials are suited selected from the group consisting of or comprising polyethylene blends (PE-Blend), thermoplastic polyurethane (TPU), ethylene vinyl acetate, polycarbonat (PC), copolyester (PET), ethylene copolymer and vinyl acetate (EVA), copolyester (PETG), and/or copolyester (PET-G) or any combination of said materials. The person skilled in the art will be aware of further possible materials or combinations thereof. Such materials are being distributed, for example, by the companies Scheu, ERKODENT, or Dreve.

The elastic moiety in the aligner ensures that the aligner can be mounted onto the teeth by the patient him-/herself without aid or devices and thus grants a comfortable mounting and demounting of the aligner. In addition, the elastic moiety decreases the likelihood of material fatigue of the aligner. In a preferred embodiment the inner surface of an aligner or at least a part thereof is composed of an elastic material. In other words: in a particularly preferred embodiment the aligner is composed of a two-component printing block material.

In a preferred embodiment the aligner according to the present invention consists of a hard, less elastic or not at all elastic side or layer, facing the oral cavity, and a soft, elastic or flexible side or layer (inner surface) facing the teeth.

In a particularly preferred embodiment of the present invention the elastic side or layer comprises or consists of an elastic material selected from the group consisting of thermoplastic polyurethane (TPU), ethylene vinyl acetate, and/or ethylene copolymer and vinyl acetate (EVA) or any combination thereof. The person skilled in the art is aware of further materials which have comparable features as TPU and/or EVA.

The aligners according to the present invention consisting of at least one elastic layer or comprising one or several portions or parts of an elastic layer can be perfectly combined with the adhesion pad according to the present invention; see also Example 1.

As aligners reduced in size (FIG. 5D) or accurately fitting (FIG. 2B) function similarly as a continuous, concave cavity, new friction pads, i.e., adhesion pads can be mounted onto the teeth also, for example, throughout the treatment without especially producing a new aligner.

As disclosed above in the context of an entire aligner, similarly also only the inner elastic layer or a portion thereof can be shaped as an embodiment reduced by 0.01% to 20%, preferentially by 0.01% to 4% in size. The above-mentioned figures referring to the reduction factor also apply for said inner surface. The reduction factor depends on the materials used for the adhesion pads and on the force to be exerted onto the teeth, because when the aligner is carried by a patient (e.g., on one tooth or several teeth or the entire jaw), said adhesion pad transmits correcting or stabilizing forces exerted by the aligner onto one or several target teeth which are to be twisted or shifted, in order to correct their position.

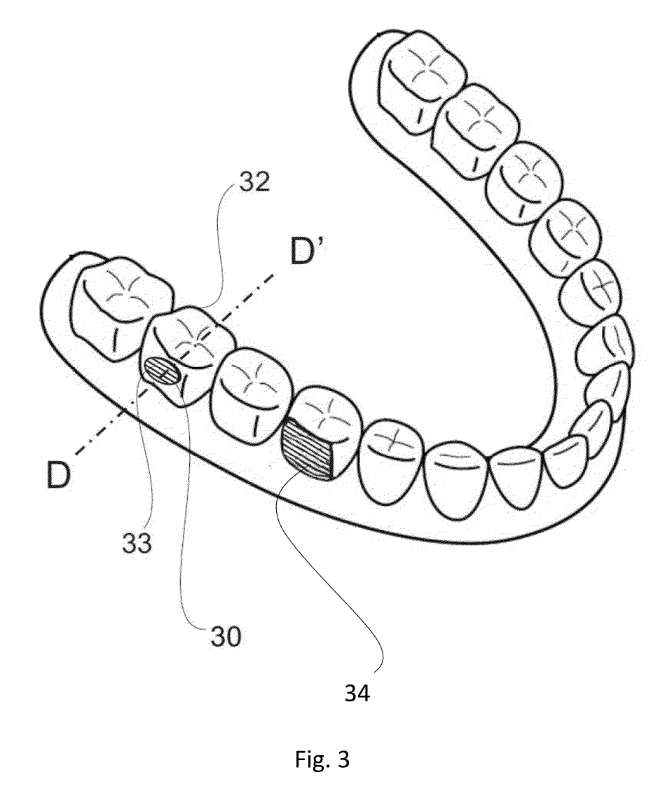

In a preferred embodiment the adhesion pad is mounted onto the entire side of a tooth, or two or more sides, see also FIG. 3 (34). If one adhesion pad or several adhesion pads are embodied in a way that they cover the entire front side and/or rear side of a tooth or of the teeth, this has following advantages according to the present invention.

First, the adhesion pad is hardly or not at all visible while speaking, as the light refraction is evenly scattered over the entire visible surface of the mounted adhesion pad, i.e., of the tooth. Second, a larger area is covered and thus also a stronger friction force is exerted that way, because the aligner has direct contact to the entire or the larger part of the adhesion surface due to its reduced size.

### EXAMPLE 1

### Comparison of the Friction of Aligners Mounted to Teeth without Adhesion Pads and to Teeth with Adhesion Pads, Respectively

The goal of this experiment was to determine the maximum force necessary for pulling off various aligner materials without and with having buccal friction pads mounted to the experimental models.

Experimental Setup:

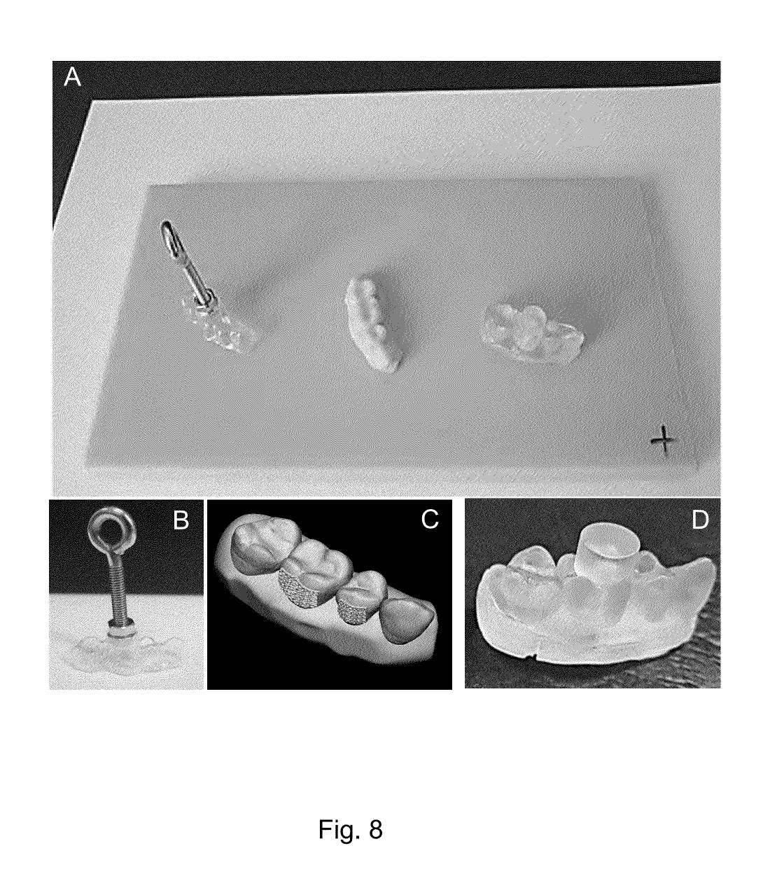

First, a high-resolution scan of the gypsum model of the upper jaw of a patient with all teeth was generated in order to create a virtual dental model of the upper jaw. Subsequently, a segment of the jaw was virtually excised for generating a partial model of the teeth 23, 24, 26 and 27 by using CAD software. The partial model was duplicated by the software in order to yield two identical virtual partial models (A+B). Then adhesion pads, so-called “friction pads”, with a profile height of 0.5 mm were attached to the buccal surfaces of the teeth 24 and 26 of partial model B using the CAD software (see FIG. 8C). Partial model B is shown in FIG. 8C. Partial model A without adhesion pads is not depicted.

For construction of experimental or pull-off models, partial models A+B were duplicated again. Partial models C+D yielded (partial model C without friction pads, partial model D with friction pads), respectively, were then mounted via their lower surfaces on a virtual plate of 20×10.5×1.2 cm in size, wherein both partial models were mounted on exactly the same position on the respective plate (not shown).

For creation of a deep-drawing model, partial model A was virtually duplicated again. This partial model E did not have friction pads attached and served for production of the aligner. Furthermore, a cylinder with a diameter of 8 mm and a height of 5 mm was attached to the occlusal surface of tooth 26 on partial model E (FIG. 8D). This cylinder served for later fixation of the fastening nut of the pull-off screw (see below).

Subsequently, partial models C, D and E were manufactured using CAM technology. FIG. 8A center shows partial model A on the plate for the experimental or pull-off model without adhesion pads. A corresponding plate with partial model B, as virtually depicted in FIG. 8C, was also generated using CAM technology and mounted to a plate as in FIG. 8A center.

On the deep-drawing model (FIG. 8D), HardCaps, DayCaps and Soft/NightCaps, as shown in the table as follows, were deep-drawn and worked out according to the criteria for aligner manufacturing. The aligner materials:

TABLE 1

| Aligner | Material | Strength | E Module |
|---|---|---|---|
| HardCaps | PETG, Copolyester | 0.8 mm | PETG: 2000 Mpa |
| | Isolation Film PE | | |
| DayCaps | PETG, Copolyester, hard side | 1.0 mm | PETG: 2000 Mpa |
| | TPU, Polyurethan, soft side | | TPU: 170 Mpa |
| | Isolation Film PE | | |
| Soft/ | PETG, Copolyester, hard side | 2.0 mm | PETG: 2000 Mpa |
| NightCaps | TPU, Polyurethan, soft side | | TPU: 170 Mpa |
| | Isolation Film PE | | |

The Soft/Night Caps comprise two layers and consist of 1 mm PETG+1 mm TPU each. The Hard Caps are consisting of 0.8 mm PETG.

In the cylindrical parts of the aligners, a steel eye bolt M 4×25 mm was fixed from occlusal by way of two counter nuts (see FIG. 8A, left 8B).

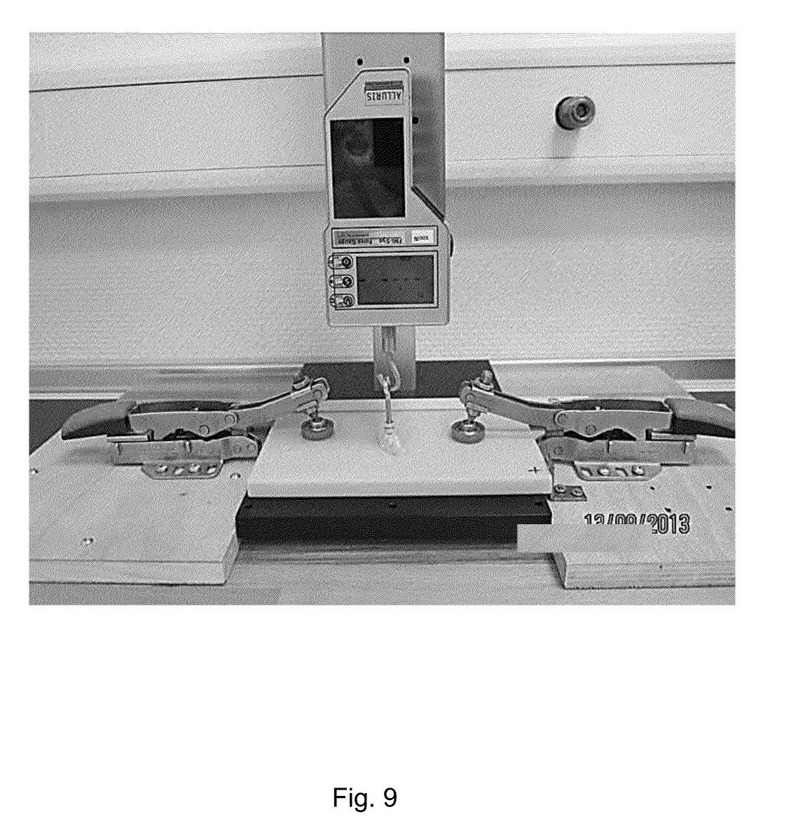

The pull-off experiments were performed by use of a force measuring device (FMI-S30, Alluris, Freiburg, Germany) integrated in a test facility (FMT-210, Alluris, Freiburg, Germany) (see FIG. 9). The experimental or pull-off models C+D could be applied reproducibly in an exactly identical position by use of a metal angle and a wood ridge mounted to the test facility. This served to guarantee for a constant pull-off direction among the different pull-off models C+D. The pull-off model was fixed to the test facility by use of two mechanical clips.

Experimental Procedure:

30 pull-off experiments each were performed per aligner material (i.e., HardCaps, DayCaps and Soft/NightCaps) with partial models C+D, respectively. In these experiments, the aligners were tested on the pull-off models without friction pads as well as on the pull-off models with friction pads (all aligners had been manufactured without cavities for friction pads, see above). The maximum force exerted for pulling off the aligner was determined. The aligner was manually mounted back to the pull-off model after the performance of each experiment.

### RESULTS

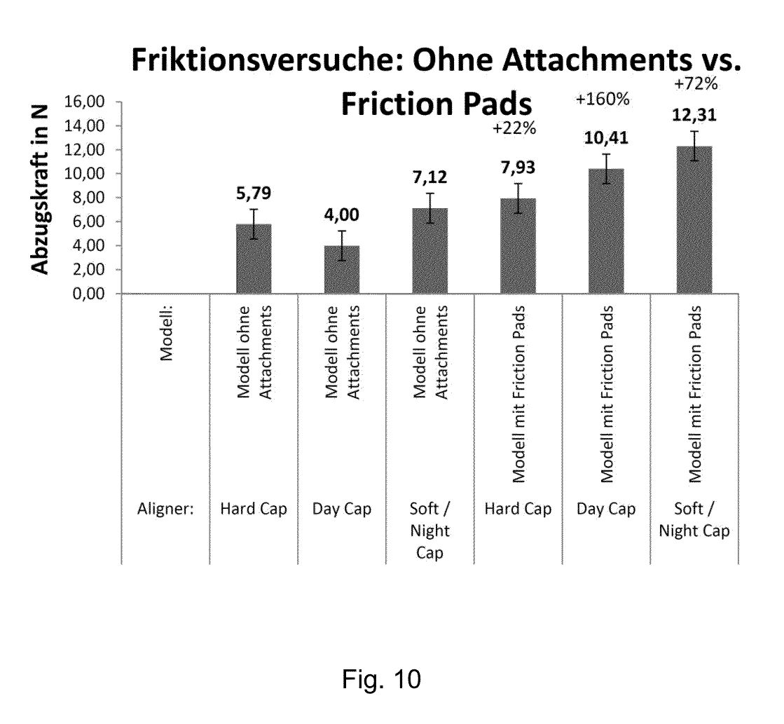

The results of pull-off experiments using all aligners (Hard-Caps, Day-Caps, Soft/Night-Caps) on pull-off models without friction pads and on pull-off models with friction pads are shown in the table in FIG. 10. “SD” represents the standard deviation from the mean. The T-test was applied for statistical analysis of the average maximum force.

The maximum force to be exerted for pulling off the aligners was increased by application of friction pads on the experimental models.

For the pull-off of HardCaps from model C (without friction pads), an average maximum force of 5.79 N (SD: 0.27) was yielded. By application of friction pads on experimental model D, the average maximum force was increased by 22% to 7.93 N (SD: 0.34).

For the pull-off of DayCaps from model C (without friction pads), an average maximum force of 4.00 N (SD: 0.67) was yielded. By application of friction pads on experimental model D, the average maximum force was increased by 160% to 10.41 N (SD: 0.18).

For the pull-off of Soft/NightCaps from model C (without friction pads), an average maximum force of 7.12 N (SD: 0.2) was yielded. By application of friction pads on experimental model D, the average maximum force was increased by 72% to 12.31 N (SD: 0.3), (see table in FIG. 10).

Overall the experiments were performed 30 times with each aligner. By application of friction pads the force to be exerted for pulling off the aligners was increased by 22% with HardCaps, by 160% with DayCaps, and by 72% with SoftCaps as compared to the respective models without adhesion pads/friction pads.

### FIGURES

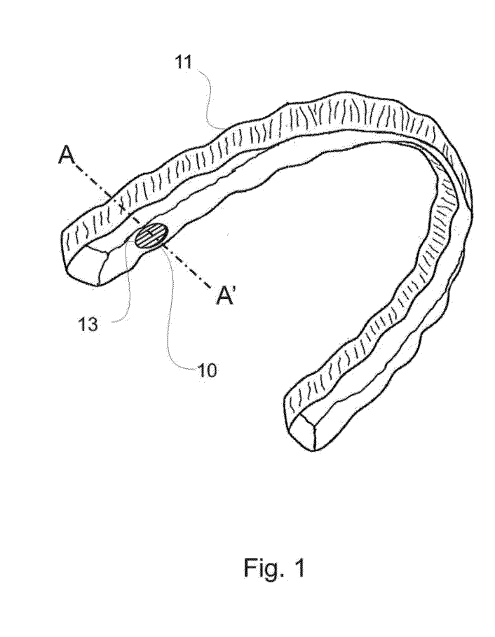

FIG. 1 shows an aligner 11 for correction of the dental position of a patient, corrected in perspective view from below. In this figure the space that is occupied by the patient's teeth when applied as intended, is visible. Said aligner is made, for example, of a transparent synthetic material. Said aligner carries an adhesion pad 10 on its inner face, which is attached there, for example, by an adhesive (“aligner mountable adhesion pads”).

Said adhesion pad essentially consists of a flat structure which comprises a modified surface that increases its adhesion to the dental surface. Said modification consists, e.g. of a structure profile 13.

When the aligner is carried by a patient (e.g. on one tooth or several teeth or the entire jaw), said adhesion pad transmits the correcting or stabilizing forces exerted by the aligner onto one target tooth or several target teeth which have to be twisted or moved in order to correct their position.

Unlike shown in FIG. 1, the aligner can comprise several adhesion pads; the adhesion pads can feature other forms (square, rectangular, polygonal, adjusted to the form of the target tooth); and/or one or several adhesion pads can also be positioned at the face of the aligner opposite the adhesion pad shown.

FIG. 2A shows an aligner 21 for correction of the dental position of a patient, corrected in perspective view from below. In this figure the space that is occupied by the patient's teeth when applied as intended, is visible. Said aligner is made, for example, of a transparent synthetic material. Said aligner carries an adhesion pad 20 on its inner face, which is an integrated component of the former and protrudes at its inner face (“aligner-integrated adhesion pad”). FIG. 2B next to it shows a second aligner 21 which does not comprise adhesion pad-mounting cavities and otherwise features identical dimensions as the aligner 21 in FIG. 2A.

Said adhesion pad essentially consists of a flat structure which comprises a modified surface that increases its adhesion to the dental surface. Said modification consists, e.g. of a structure profile 23.

Unlike shown in FIG. 2A, the aligner can comprise several adhesion pads; the adhesion pads can feature other forms (square, rectangular, polygonal, adjusted to the form of the target tooth); and/or one or several adhesion pads can also be positioned at the face of the aligner opposite the adhesion pad shown.

FIG. 3 shows a jaw of a patient 31, or a positive model thereof, as well as an adhesion pad 30, attached to the surface of a tooth 32, which needs to be twisted or moved in order to correct its position (“tooth-mountable adhesion pads”). Said adhesion pad essentially consists of a flat structure which comprises a modified surface that increases its adhesion to the dental surface. Said modification consists, e.g. of a structure profile 33. Another embodiment of an adhesion pad is also depicted in FIG. 3, wherein the adhesion pad 34 is stretched over the entire lateral surface of a tooth. The adhesion pad can also be attached around two or three or all faces of the tooth (not shown).

Unlike shown in FIG. 3, the aligner can comprise several adhesion pads; the adhesion pads can feature other forms (square, rectangular, polygonal, adjusted to the form of the target tooth); and/or one or several adhesion pads can also be positioned at the face of the aligner opposite the adhesion pad shown.

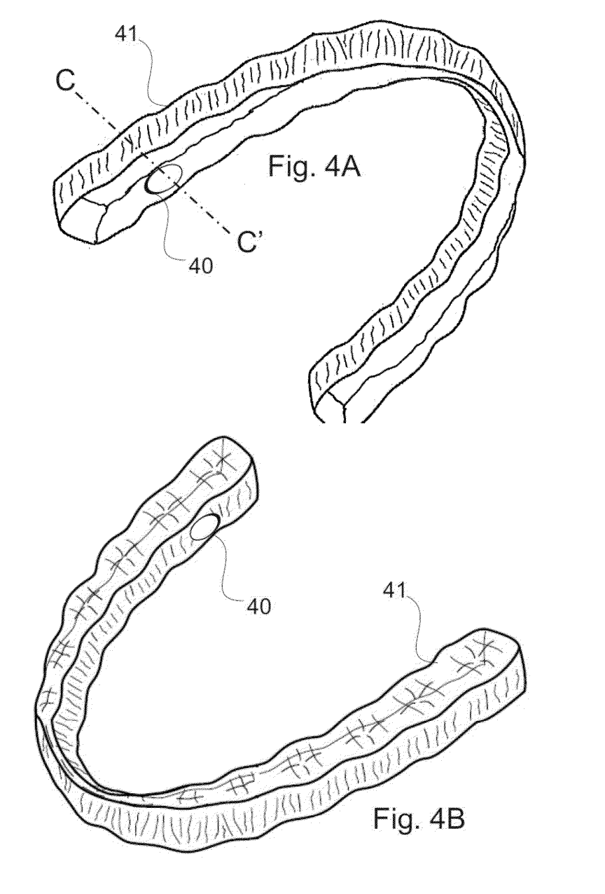

FIGS. 4A and 4B show transfer trays 41 comprising cavities 40 for reception of tooth-mountable adhesion pads 40. Such transfer tray serves for indirect transfer of said tooth-mountable adhesion pads to the dental surface. Alternatively, the cavity 40 of the transfer tray 41 can also be filled with a polymerizing material (e.g. a light-hardening synthetic material). When the transfer tray is placed onto one tooth or several teeth or the entire jaw of the patient, the polymer-forming material can be polymerized and thereby hardened on the dental surface. When the transfer tray is removed, a tooth-mountable adhesion pad remains attached at the dental surface.

Unlike shown in FIG. 4, the transfer tray can comprise several cavities; the cavities can feature other forms (square, rectangular, polygonal, adjusted to the form of the target tooth); and/or one or several cavities can also be positioned at the face of the tray opposite the cavity shown.

However, FIG. 4 can also show an aligner 41 comprising a cavity 40 whose dimensions and position correspond to the adhesion pad(s) positioned or to be positioned on the tooth or the teeth. For use of such an aligner tooth-mountable adhesion pads are therefore required which fit into said corresponding cavities when the aligner is being carried after the aligner has been mounted over the adhesion pads. Thereby a secure fit and an efficient force transmission is been granted.

Unlike shown in FIG. 4, the aligner trays can comprise several cavities; the cavities can feature other forms (square, rectangular, polygonal, adjusted to the form of the target tooth); and/or one or several cavities can also be positioned at the face of the aligner opposite the cavity shown.

FIG. 5A shows a cross section through an aligner along the line A-A′ in FIG. 1. Thereby the features of an aligner-mountable adhesion pad 51 are shown which comprises a modified surface 52 that increases attachment of the same to the dental surface.

FIG. 5B shows a cross section through an aligner along the line B-B′ in FIG. 2. Thereby the features of an aligner-integrated adhesion pad 53 are shown which comprises a modified surface 54 that increases attachment of the same to the dental surface.

FIG. 5C shows a cross section through a transfer tray along the line C-C′ in FIG. 4. Thereby the features of a cavity 55 for reception of a tooth-mountable adhesion pad or for filling with a polymerizing material are shown.

FIG. 5C can also show a cross section through an aligner along the line C-C′ in FIG. 4. Thereby the features of a cavity 55 are shown whose dimension and position correspond to those of the adhesion pad(s) positioned or to be positioned on the teeth.

FIG. 5D shows a cross section through an aligner along the line B′-B′ in FIG. 2B which, however, does not comprise a cavity (56) for the adhesion pads but otherwise is identical with the aligner of FIG. 4 (not shown).

In addition, an aligner without cavities (56) can be used which as depicted by comparison with the aligner according to 5C (see dashed line) represents an almost identical but smaller representation of the aligner from FIG. 5C. This is visualized by the distance 57. The depicted dimensions of the smaller aligner of FIG. 5D without cavities (56) serve only for demonstration and do not correspond to actual dimensions.

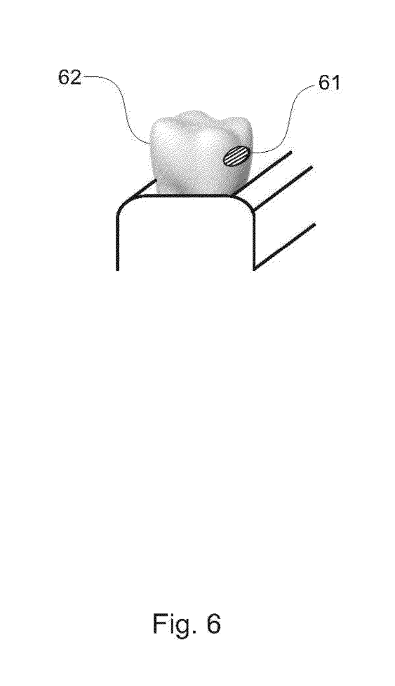

FIG. 6 shows a cross section through a tooth along the line D-D′ in FIG. 3, which demonstrates how the tooth-mountable adhesion pad 61 is placed on the tooth 62 which needs to be twisted or moved in order to correct its position. Unlike shown in FIG. 6, the adhesion pad can feature other forms (square, rectangular, polygonal, adjusted to the form of the target tooth).

FIG. 7 shows the jaw of a patient, or a model thereof, and its 3-dimensional alignment to the three Cartesian axes in a 3-dimensional system. A Cartesian coordinate system for a 3-dimensional area consists of an arrangement of three axes, two of which always form a rectangular angle with each other. These axes are often termed by x, y and z.

In one embodiment of the present invention the physical model of one tooth or several teeth or of the entire jaw is decreased in size along at least one of the three Cartesian axes of the 3-dimensional coordinate system by a value of between ≧0.01% and ≦20% as compared to one target tooth or several target teeth or the entire jaw of the patient.

FIG. 8: A. Aligner with pull-off device, pull-off model (without adhesion pads), and deep-drawing model (from left to right). B. Enlarged view of the pull-off device. C. Pull-off device with adhesion pads. D. Deep-drawing model with cylinder.

FIG. 9: Test facility with force measuring apparatus, fixation clips, fixed experimental model and aligner with pull-off steel eye bolt as shown in FIG. 8B, wherein the respective aligners HardCaps, DayCaps and SoftCaps were fixed with one steel eye bolt each and measured.

FIG. 10: Results of pull-off experiments of all aligners (Hard-Caps, Day-Caps, Soft/Night-Caps) on models without friction pads and on models with friction pads are shown in the table. 30 experiments per aligner were performed and the pull-off force N was measured. Percentage values refer to the comparison between aligner with friction pads and aligner without friction pads. For example, 160% more pull-off force is required for a DayCap aligner if the same is positioned on a pull-off model with friction pads attached at the dental positions 24 and 26, as compared to a pull-off model without friction pads.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

1. Adhesion pad for fastening an orthodontic aligner, wherein the adhesion pad comprises a substantially flat structure adapted to be applied to a surface of at least one tooth, wherein said adhesion pad has at least one side having a modified surface, which increases the adhesion of the adhesion pad to the orthodontic aligner.

2. The adhesion pad according to claim 1, wherein said flat structure
a) can be arranged on an inner surface of said aligner; or
b) is an integrated region of said aligner that protrudes from the inside surface of the aligner.

3. Adhesion pad according to claim 1, wherein said modified surface is a surface comprising an increased adhesion to either (i) an orthodontic aligner or (ii) a tooth surface.

4. Adhesion pad according to claim 3, wherein said modification is selected from the group comprising (a) measures to increase the friction coefficient of the surface, and (b) measures to furnish said surface with a micro or macro profile.

5. Process for production of an adhesion pad according to claim 1, wherein the process comprises the following steps:
a) determining the region of one tooth or several teeth, or of an aligner, where the adhesion pad shall be mounted, and
b) producing the adhesion pad.

6. Process according to claim 5, further comprising a step of generating a virtual CAD model of the adhesion pad, wherein said CAD model optionally comprises at least on one side a micro or macro surface profile adapted to increase adhesion of the adhesion pad to the tooth surface or to an aligner.

7. Process according to claim 6, further comprising at least one step selected from the group comprising:
a) virtual positioning of said virtual CAD model onto the surface of a virtual CAD model representing at least one target tooth, in such a way that the virtual CAD model of the adhesion pad is positioned at the surface of said virtual model of the at least one target tooth,
b) virtual positioning of a negative form of said virtual CAD model onto the surface of a virtual CAD model representing at least one target tooth in such a way that the virtual CAD model of the adhesion pad creates a cavity embedded in the surface of the virtual CAD model of the at least one target tooth, and wherein said cavity takes on the form and/or the surface profile of the adhesion pad, and
c) virtual positioning of said virtual CAD model onto the inner surface of a virtual CAD model of an orthodontic aligner in such a way that the virtual CAD model of the adhesion pad is positioned at an inner surface of said virtual CAD model of the orthodontic aligner.

8. Process according to claim 7, wherein the virtual CAD model representing at least one target tooth is generated by a 3D scan of a cast, which cast has been produced by casting at least one target tooth of a patient.

9. Process according to claim 8, comprising a further process step for production of at least one of
a) at least one physical model of an adhesion pad,
b) at least one physical model of at least one target tooth, which are comprising at least one model of an adhesion pad attached to theif surfaces of the at least one physical model of the at least one target tooth, or
c) at least one physical model of at least one target tooth comprising a cavity embedded in a surface of the at least one physical model of the at least one target tooth, wherein said cavity takes on the form and/or the surface profile of the adhesion pad, and
d) on the basis of the respective virtual CAD models and using a CAM technology.

10. Process for production of an orthodontic aligner for use in combination with an adhesion pad according to claim 4, further comprising a step for production of one or more physical models of at least one target tooth without adhesion pads, on the basis of a virtual model of the at least one target tooth by use of CAM technology.

11. Process for production of at least one orthodontic aligner, wherein said at least one aligner is produced by deep drawing over a physical model of at least one target tooth and wherein said model is produced by a method according to one of steps a) or b) of claim 9.

12. Process for production of one or more transfer trays, wherein said transfer tray is produced by deep drawing over a physical model of one target tooth, or several target teeth, or the entire jaw, and wherein said model is produced by a method according to step b) of claim 9.

13. Process according to claim 10, wherein in the virtual CAD model representing the at least one target tooth the position of the at least one tooth is manipulated by hand or by a given algorithm.

14. Process according to claim 10, wherein the position of the at least one tooth in the virtual CAD model is modified by said manipulation.

15. Process according to claim 14, wherein said manipulation of the virtual CAD model creates at least one transitional tooth position, and optionally also creates a preliminary or final target teeth position.

16. Process according to claim 15, wherein said manipulation of the virtual CAD model serves for production of at least one orthodontic aligners.

17. Orthodontic aligner comprising at least one aligner-integrated adhesion pad, wherein said aligner is produced by a method according to claim 16.

18. Transfer tray comprising at least one cavity configured to receive at least one adhesion pad mounted onto a tooth model, or for polymerizable material, wherein said transfer tray is produced by a method according to claim 12.

19. Set of two or more orthodontic aligners which are produced according to claim 16, wherein different orthodontic aligners of said set vary in their form among one another.

20. Process for production of an orthodontic aligner with improved transmission of correcting forces onto one tooth, or several teeth, or on the entire jaw of a patient, comprising the following steps:
a) production of a physical model of one target tooth or several target teeth or the entire jaw, wherein the model is reduced in size as compared to the target teeth or the entire jaw of the patient, respectively,
b) production of an orthodontic aligner based on this model.

21. Process according to claim 20, wherein the physical model of one target tooth or several target teeth or the entire jaw is reduced in size along at least one of the three Cartesian axes of the three-dimensional coordinate system by a value of between ≧0.01% and ≦20% as compared to the one target tooth or several target teeth or the entire jaw of the patient, respectively.

22. Process according to claim 20, wherein the physical model reduced in size of one target tooth or several target teeth or the entire jaw is produced by the steps of
a) generating a 3D scan of a cast which cast has been produced based on a cast of one target tooth or several target teeth or an entire jaw of a patient using a suitable material,
b) generating a virtual CAD model representing one target tooth or several target teeth or the entire jaw of a patient,
c) optionally: reducing said virtual CAD model in size, and
d) generating a physical model reduced in size of said virtual CAD model by use of CAM technology.

23. Process according to claim 22, wherein the virtual CAD model representing one tooth or several teeth or the entire jaw of a patient is manipulated, either before or after reduction in size, by a person or by a given algorithm.

24. Process according to claim 23, wherein a position of at least one tooth in the virtual CAD model is modified by said manipulation.

25. Process according to claim 24, wherein said manipulation of the virtual CAD model serves to generate one or several transitional teeth positions, and optionally also to generate a preliminary or final target teeth position.

26. Process according to claim 24, wherein said manipulation of the virtual CAD model representing one target tooth or several target teeth or the entire jaw serves to produce one or several orthodontic aligners.

27. An orthodontic aligner, wherein said aligner is slightly smaller than one target tooth or several target teeth or the entire jaw of a patient.

28. A set of two or more orthodontic aligners, which are produced according to claim 26, wherein the different aligners of said set vary in their form among one another.
